(19) United States
(12) Patent Application Publication
(10) Pub. No.: US 2010/0303457 A1
(43) Pub. Date: Dec. 2, 2010

(54) SIGNAL QUALITY DETECTOR

(75) Inventors: Erich Gottwald, Holzkirchen (DE); Werner Paetsch, Munchen (DE)

Correspondence Address: LERNER GREENBERG STEMER LLP, P O BOX 2480, HOLLYWOOD, FL, 33022-2480, US

(73) Assignee: Nokia Siemens Networks GmbH & Co. KG, Munchen (DE)

(21) Appl. No.: 12/301,165

(22) PCT Filed: Apr. 25, 2007
(86) PCT No.: PCT/EP07/54036

§ 371 Date: Jul. 13, 2010

(30) Foreign Application Priority Data
Jul. 15, 2006 (DE) 10 2006 023 184.8

(51) Int. Cl. H04B 10/08

(52) U.S. Cl. 398/25

(57) ABSTRACT

In the signal quality detector (7, 8, 10), a 3R-regenerated electrical received signal (REDS) is correlated with a non-regenerated received signal (EDS). The result is a direct measure of the correlation between non-regenerated and regenerated received signals and can be used for controlling a PMD-compensator (3).

CLAIM FOR PRIORITY

This application is a national stage application of PCT/EP2007/054036, filed Apr. 25, 2007, which claims the benefit of priority to German Application No. 10 2006 023 184.8, filed May 17, 2006, the contents of which hereby incorporated by reference.

### TECHNICAL FIELD OF THE INVENTION

The invention relates to a signal quality detector for a PMD compensator which is supplied with an optical received signal converted into an electrical received signal.

### BACKGROUND OF THE INVENTION

In optical networks, the transmission properties of the optical fibers change quickly. At high data rates, this results in interference which is caused particularly by PMD (Polarization Mode Dispersion) and chromatic dispersion. In the case of switched networks, it is likewise necessary to react quickly to the data transmitted via different links and to aim for optimum equalization.

Rapid quality assessment of the received optical signals is therefore of great benefit to adaptive compensators. In the case of optical receivers, a quality criterion can also be used to set the sampling threshold and sampling time for the data. Particularly in the case of rapidly changing polarization mode dispersion, rapid recognition of the quality is advantageous as a prerequisite for rapid compensation. Compensation methods which measure the PMD and set a PMD compensator of simple design are ruled out for this, because they are firstly very complex and secondly do not react quickly enough to keep system downtimes below a guaranteed value. To achieve improved compensation, there remain only methods which determine the quality of the received signal in a sufficiently short time for it to be possible to set a PMD compensator comprising many stages in optimum fashion sufficiently quickly.

A PMD compensation method of this kind is described in the application DE 19 941 150 A1, for example. The received signal is subjected to spectral analysis, following optoelectrical conversion, using three electrical filters with different bandwidths (or cut-off frequencies), for example, and the intensities in the three bands are used to draw conclusions about the PMD of the system. By its nature, the method is dependent on the data rate and is problematical for higher-order PMD. Other methods involve analysis of the signal quality by evaluating histograms or else, if an error-correcting code is used, are based on the bit error rate.

In a paper by F. Buchali, “Fast Eye Monitor for 10 Gbit/s and its Application for Optical PMD Compensation”, Optical Fiber Communication Conference, OFC 2001, Vol. 2, TuP5-1-TuP5-3, two parallel-connected decision-maker stages and an EXOR gate are used to measure the eye opening of a binary received signal on the basis of the decision-maker threshold for different settings of a PMD compensator. At the largest eye opening, the PMD compensator is set best.

European patent application EP 1 349 300 A1 describes a reception device for noisy optical signals with ??? feedback signal by correlating the received signal to an uncorrelated signal. Only if there are distortions in the received signal is a correlation factor different than zero obtained which is supplied to a PMD compensator in order to produce a compensation function.

### SUMMARY OF THE INVENTION

The invention discloses a fast and reliable signal quality detector for determining the signal quality. In particular, the signal quality detector is intended to be suitable for controlling a PMD compensator.

One embodiment according to the invention, the correlation in the time domain minimizes the complexity. The continual comparison of the actual value of the received signal with its setpoint value provides for reliable ascertainment of an error signal even in the case of highly distorted signals. The integration time can be made dependent on the signal quality.

In the simplest case, it is sufficient to compare the arithmetic signs of the reconstructed signal and the nonreconstructed signal. An optimum error signal is obtained when the analog received signal is simulated by a filter from the reconstructed received signal and said analog received signal is compared with the nonreconstructed analog signal.

For the control, it is possible to use known optimization methods. In general, it is advantageous to minimize the first-order PMD first by setting all the compensation elements uniformly and only then to allow further optimization steps to follow. The invention is explained in more detail with reference to two figures, in which:

### BRIEF DESCRIPTION OF THE DRAWINGS

FIG. 1 shows a diagram of the signal quality detector in a PMD compensation arrangement.

FIG. 2 shows a simplified version of the signal quality detector.

FIG. 3 shows a variation of the signal quality detector.

### DETAILED DESCRIPTION OF THE INVENTION

The invention is explained in more detail by way of example with reference to a reception device for PMD compensation, but can likewise be used for controlling other compensators, or elements which influence the signal quality. Similarly, the invention can provide a direct measure of the signal quality.

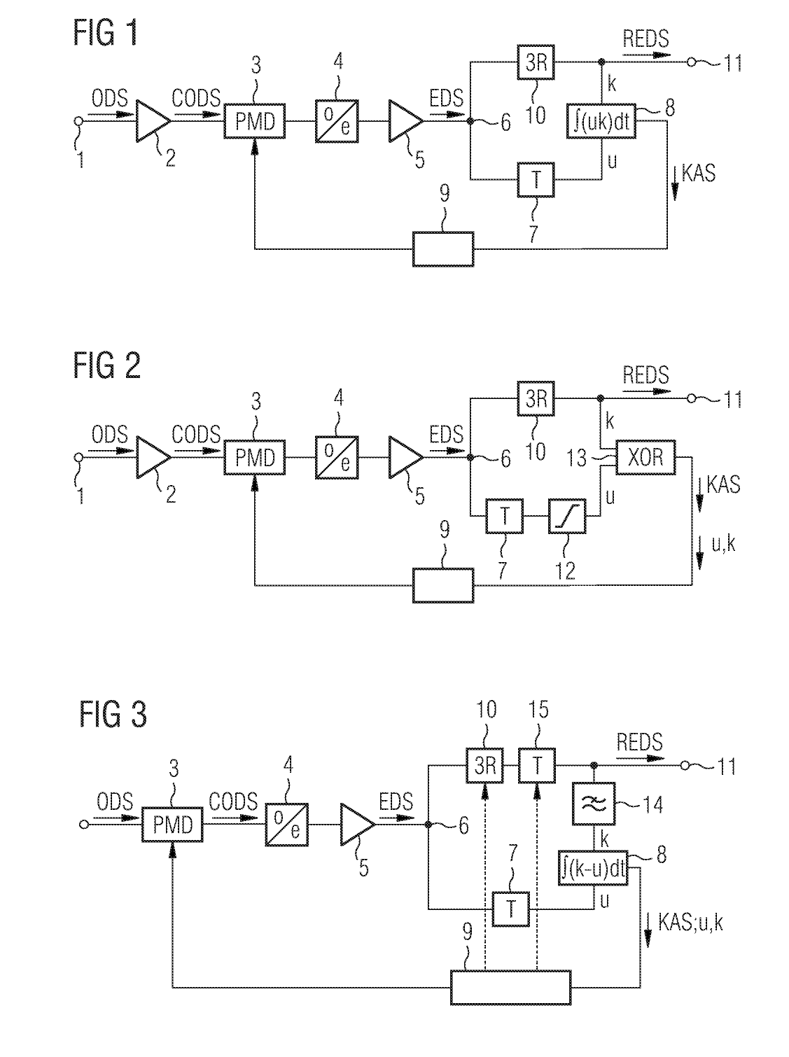

FIG. 1 shows a reception device equipped with a PMD compensator 3 and a signal quality detector 7, 8, 10. A synchronous optical received signal ODS (optical binary data signal) is supplied to the input 1 of the reception device. First of all, it is amplified in an optical reception amplifier 2 and can then pass through a dispersion-compensating fiber (not shown) before it is supplied to a PMD compensator 3. The latter may be of any design in principle and performs the most exact compensation for the PMD possible in line with its design. The optical received signal CODS compensated for in this way is supplied to a demodulator 4 which demodulates it and converts it into an electrical received signal EDS. This signal is amplified by an electrical amplifier 5, which is generally designed jointly with the demodulator 4. In the simplest case of amplitude modulation, the demodulator 4 is a photodiode which is simultaneously used as an opto-electrical converter. Automatic gain control for the electrical amplifier 5 keeps the amplitude of the electrical received signal EDS constant at its output. The electrical received signal EDS is supplied to a correlator 8 from a branch point 6 on two paths. In the upper path, it is first of all supplied to a 3R regenerator 10 which outputs a completely regenerated synchronous received signal REDS. The pulse shape of the data bits is also intended to correspond as far as possible to the pulse shape for the ideally compensated for but nonregenerated received signal. The regenerator may have a dedicated clock regenerator and an internal threshold value decision-maker, but may be of any design in principle.

In the lower path, the electrical received signal EDS is routed via a delay element 7 and, like the regenerated received signal REDS, supplied to the correlator 8 operating in the time domain; the input signals of the correlator 8 are denoted by k and u. In this case, the delay element 7 compensates for the delay difference between the two signals. The correlator correlates the signals k and u and hence, over time, the regenerated received signal REDS and the nonregenerated received signal EDS.

With ideal PMD compensation, the regenerated received signal and the nonregenerated received signal will largely match, and the output of the correlator outputs a maximum output signal in the form of a correlation product KAS as a measure of the match or difference between the two signals. In another embodiment, a minimum error signal is produced as the “correlation product”. The evaluation is simplified if the regenerated and non-regenerated received signals have the same amplitudes and the difference between the signals serves as a control criterion. If the compensation is insufficient, the difference between the two signals is greater by nature and so is the error signal which is output at the output of the correlator. A control/regulation unit 9 varies the setting of the PMD compensator 3 until the differences between the regenerated received signal and the nonregenerated received signal have reached a minimum. In this case, a prescribed optimization method is used.

FIG. 2 shows an arrangement in which the correlator 8 is of particularly simple design. It contains only a position-maker stage 12 which distinguishes between the logic zero and the logic one and sends an uncompensated binary received signal u to an input of an Exclusive-Or gate 13 whose second input is supplied with the regenerated received signal REDS. In this case, the 3R regenerator can likewise deliver a binary signal, or an input of the Exclusive-Or gate acts as a position-maker threshold. The Exclusive-Or gate assesses only the delay differences between the two signals u, k and then integrates them in the control/regulation unit 9. Optimization is again performed by adjusting the parameters of the PMD compensator.

The control/regulation unit 9 can also be used to control the decision-maker stage 12 and the 3R regenerator 10, for example. The correlator can also additionally provide information about the averaged duration of the 1 pulses for the two signals u and k, which means that it can also be used to set the decision-maker threshold of the 3R regenerator.

The arrangement in FIG. 3 shows a further-developed signal quality detector. The fundamental element is a fixed or variable “system filter” 14 which simulates the complete transmission link (possibly from a 3R regenerator in the transmission link), including transmission and reception device. Ideally, the filter simulates the PMD-independent distortions in the transmission link. They then correspond to the PMD-independent distortions in the nonregenerated signal and therefore do not provide a relevant contribution to the correlation product any longer. ??? of a difference between the input values u and k allows the correlator to be trimmed to zero, in the ideal case, by setting the PMD compensator if the input signal k derived from the received signal REDS matches the nonregenerated received signal/input signal u.

In this case, the control/regulation unit 9 also evaluates the input signal of the correlator 8, and there is also optimization of the threshold of the 3R regenerator and of a variable delay element 15, which is arranged in the upper signal path in this case, in order to optimize the time correlation between the compensated and uncompensated input signals for the correlator.

As already mentioned in the introduction to the description, the signal quality detector can generally be used to assess the signal quality and to control the elements which influence the signal quality. It is thus also possible to control the wavelength of a transmission laser, for example, in order to optimize the laser frequency for filters which cause distortions (particularly Bragg filters).

1. A signal quality detector, particularly for a PMD compensator, which is supplied with an optical received signal (ODS) converted into an electrical received signal (EDS), characterized by
a 3R regenerator (10) which regenerates the electrical received signal (EDS) and outputs a regenerated received signal (REDS), a correlator (8) which is supplied with the electrical received signal (EDS) and the regenerated electrical received signal and which outputs a correlation signal (KAS) which is rated as a measure of the difference or match between the regenerated received signal (REDS) and the nonregenerated electrical received signal (EDS).

2. The signal quality detector as claimed in claim 1, characterized
in that the nonregenerated electrical received signal (EDS) is supplied to the correlator (8) via a delay element (7).

3. The signal quality detector as claimed in claim 1 or 2, characterized
in that a filter (14) simulating the transmission link is connected between 3R regenerator (10) and correlator (8).

4. The signal quality detector as claimed in claim 1, 2 or 3, characterized
in that a controllable delay element (15) is connected in the signal path of the nonregenerated electrical received signal (EDS) or of the regenerated received signal (REDS).

5. The signal quality detector as claimed in claim 1, 2 or 3, characterized
in that the correlator is in the form of an EX-OR gate (13) which has a threshold value circuit (12) connected upstream of it.

6. The signal quality detector as claimed in claim 1, 2 or 3, characterized
in that the correlator (8) is in the form of a multiplier with a downstream integrator or in the form of a subtractor with a downstream integrator.

7. The signal quality detector as claimed in claim 1, 2 or 5, characterized
in that the 3R regenerator (10) or the threshold value circuit (12) are controllable and are controlled by a control/regulation device (9) which evaluates the nonregenerated electrical received signal (EDS) and the regenerated received signal (REDS).

8. The use of a signal quality detector as claimed in one of the preceding claims, characterized
in that it is used for controlling a PMD compensator (3), a dispersion compensator or for tuning a transmission laser.
